(19) United States
(12) Patent Application Publication
(10) Pub. No.: US 2012/0254931 A1
(43) Pub. Date: Oct. 4, 2012

(54) Content Extraction for Television Display

(75) Inventors: Ant Oztaskent, Surrey (GB); Andrew Gildfind, Brixton (GB)

(73) Assignee: GOOGLE INC., Mountain View, CA (US)

(21) Appl. No.: 13/426,954

(22) Filed: Mar. 22, 2012

Related U.S. Application Data
(63) Continuation of application No. 13/079,375, filed on Apr. 4, 2011.

(51) Int. Cl. H04N 21/858

(52) U.S. Cl. 725/112

(57) ABSTRACT

Methods, systems, and apparatus, including computer programs encoded on a computer storage medium, for a display device that, in response to receiving a network address from a personal computing device, retrieves and presents network based electronic media. In one aspect, a method includes receiving at a user device a first resource referenced by a first resource address, and the first resource includes a second resource address referencing a second resource that is content that is displayed in a content display environment in the first resource page. In response to a selection of the display of the content in the content display environment, the method provide the second resource address to the television device in response to determining that a television device in data communication with the user device has a processing capability to retrieve the content from the second resource address and display the content.

### CROSS-REFERENCE TO RELATED APPLICATION

This application is a continuation of U.S. application Ser. No. 13/079,375, filed on Apr. 4, 2011, entitled “Content Extraction for Television Display,” the entire contents of which are hereby incorporated by reference.

### BACKGROUND

This specification relates to television processing.

Some personal electronic computing devices, such as laptop computers and smartphones, are capable of presenting content retrieved from the Internet and other networks. These devices are generally designed to provide such content to the user in a personal manner (e.g., the device is generally configured for use and viewing by a single user). In some cases, this content can include video content that is viewable on the personal electronic computing devices.

Display devices, such as televisions, generally display video content provided by terrestrial broadcasts, or by cable and satellite programming providers. High definition televisions (HDTVs) are generally capable of decoding video content compressed according to the MPEG-2 and H.264 standards. In addition to decoding and displaying compressed broadcast video, some display devices are capable of connecting to a network in order to present video content retrieved from networked personal computers and/or from Internet-based sources such as online movie rental services. In general, these display devices provided the user with a user interface with which the user interacts in order to search for and select the content that is to be presented on the display device.

### SUMMARY

In general, one innovative aspect of the subject matter described in this specification can be embodied in methods that include the actions of receiving, at a user device, a first resource referenced by a first resource address, wherein the first resource defines a first resource page and a content display environment in the first resource page, and includes a second resource address referencing a second resource, the second resource defining content that is displayed in the content display environment in the first resource page; displaying, at the user device, the first resource page and the content display environment; receiving, at the user device, the content referenced by the second resource address and display the content in the content display environment; receiving, at the user device, a user selection of the display of the content in the content display environment; determining, by the user device, whether a television device in data communication with the user device has a processing capability to retrieve the content from the second resource address and display the content; and in response to determining that the television device has the processing capability to retrieve the content from the second resource address and display the content, providing, by the user device, the second resource address to the television device. Other embodiments of this aspect include corresponding systems, apparatus, and computer programs, configured to perform the actions of the methods, encoded on computer storage devices.

Another innovative aspect of the subject matter described in this specification can be embodied in methods that include the actions of receiving programming content over a television network and process the television programming content for display on a television display device; receiving a resource address from a user device over a local area network, the resource address referencing content; receiving over a television provider network the content from the resource address; and processing the content for display on the television display device. Other embodiments of this aspect include corresponding systems, apparatus, and computer programs, configured to perform the actions of the methods, encoded on computer storage devices.

Particular embodiments of the subject matter described in this specification can be implemented so as to realize one or more of the following advantages. Because the television devices need only be able to retrieve data from a location specified by a resource identifier, the television device may not have the sophisticated operating systems of portable computing devices. Instead, compatibility checking and a contextual user interface can be realized in the portable computing device. Such a function distribution is also reflective of the consumer model applied to television set top boxes and user devices. For example, many television set top boxes are at a customer location for multiple years. Accordingly, television set top boxes do not undergo product changes as rapidly as consumer devices, such as smart phones and portable computer devices. Thus, relegating the less complex processing operations to the set top boxes (e.g., retrieving encoded video data over a TCP/IP connection) allows developers to devote more resources to providing updated processing and user interface features with the user devices. For example, the users are more likely to upgrade their laptops and cell phones every several years, yet the television (or set top box) may have an expected lifetime of five years, ten years, or longer. By placing the burden of browsing and searching on the personal computing devices rather than the television processing device, such efforts can be performed using hardware and software that is more likely than the television to be kept up-to-date relative to the evolution of Internet, Web, and other network technologies.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which content extracted from an open network can be provided to a television processing device for display on a television display device.

FIG. 2 is a block diagram illustrating an example flow for providing content to a television processing device by use of a resource address.

FIG. 3 is a block diagram illustrating an example flow for providing content to a television processing device by use of transcoding.

FIG. 4 is a flow diagram of an example process for providing content extracting from an open network to a television processing device.

FIG. 5 is a flow diagram of an example process for selecting a content provisioning process that is dependent on television processing device capabilities.

FIG. 6 is a flow diagram of an example process for generating a command user interface at a user device in response to providing content to a television processing device.

FIG. 7 is a flow diagram of an example process of processing content at a television processing device.

Like reference numbers and designations in the various drawings indicate like elements.

### DETAILED DESCRIPTION

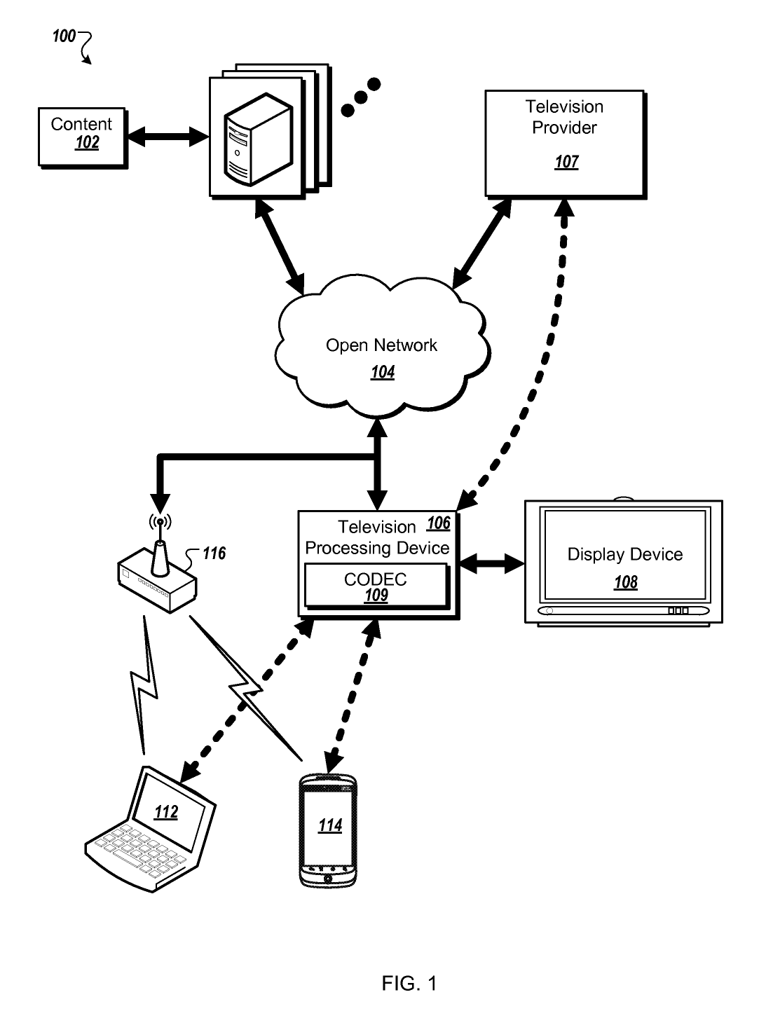

FIG. 1 is a block diagram of an example environment 100 in which content 102 extracted from an open network 104 can be provided to a television processing device 106 for display on a television display device 108. In general, a group of users gather around a television or other such display device while individually browsing video or other multimedia content on their laptops, cell phones, pad computers, or other such personal computing devices. When a user finds content that he or she wishes to share with the group, such as a humorous video hosted on a web site, the user can use his or her personal computing device to communicate with a processing device, which can be external or internal to the television (e.g., a set top box), to request the processing device to retrieve the content and display the content on the television.

The user can thus browse for media substantially without interfering with the other users' television viewing (e.g., without arguing over control of the television) and without requiring the processing device to provide rich browsing and user interface capabilities. Additionally, the user is able to share multimedia content with the entire group by using the television rather than requiring the group to huddle around the relatively smaller screen of his or her personal computing device.

Referring to FIG. 1, the television processing device 106 processes signals (e.g., terrestrial television broadcast signals, satellite television signals, cable television signals, Internet protocol television data streams) provided by a television provider 107 for display on the display device 108. Users can browse the Internet for the content 102, such as video or other media content using personal computing devices such as a user device 112 and 114, and then use the user devices 112, 114 to direct the television processing device 106 to display the content 102 on the display device 108.

The television processing device 106 includes a video codec module 109 that decodes compressed video (e.g., MPEG-2, MPEG-4) such as high definition television (HDTV) signals. In some implementations, the television processing device 106 can be a collection of video processing hardware integrated into the display device 108. In some implementations, the television processing device 106 can be a device that is external to the display device 108, such as a set-top box, a video game console, an Internet-connected DVD or Blu-Ray player, or other appropriate device that can provide the content 102 for display by the display device 108.

The content 102 is made available through a collection of media providers 110 (e.g., web sites). In some implementations, the media providers 110 provide web pages that include media content such as video, audio, still images, shared desktops, or other appropriate media. In some situations, the content 102 is encoded using compression standards that are compatible with the video codec module 109.

The user devices 112 and 114 connect to the open network 104 through a wired or wireless connection to a router 116. In some implementations, the user devices 112 and 114 can be personal computers, smartphones, netbooks, tablet computers, pad computers, or any other appropriate form of electronic device that a user can interact with to browse for the content 102. In some implementations, the open network 104 can be the Internet. In some implementations, the user devices 112 and 114 can connect to the open network 104 through a private network such as a private local area network or a cellular data network.

In use, users interacting with the user devices 112 and 114 browse for the content 102 provided by the media providers 110. When the user comes across an item of the content 102 that he or she wants to view on the display device 108 (e.g., to share an Internet video with other people in the same room, or to just display the video on a television), the user can command the user devices 112 or 114 to send an identifier of the content to the television processing device 106. In some implementations, the identifier can be a uniform resource locator (URL) for the content 102.

In some implementations, the television processing device 106 is capable of processing the content 102 for display, and can directly decode the content 102 for display on the display device 108. For example, content 102 may be an MPEG-2 encoded video stream, that the video codec module 109 is capable of decoding. The television processing device 106 can access the content 102 using a URL provided by the user device 112 or 114, and decode the content 102 through the video codec module 109 so the content 102 can be displayed on the display device 108. The access to the content can be by use of the open network 104 or the network of the television provided 107.

In some situations, the television processing device 106 may not capable of processing the content 102 for display. In these situations, the user device 112 or 114 can transcode the content 102 into a format that the television processing device 106 is capable of decoding and provide the decoded content to the display device 108. In some implementations, the user device 112 or 114 can perform codec transcoding. For example, the video codec module 109 can be capable of processing MPEG-2 and H.264, but the content 102 may be encoded using H.263 or Theora. In such examples, the user device 112 (or 114) can retrieve the content 102, convert or transcode the content 102 to a format that is compatible with the television processing device 106, and then provide the transcoded content to the television processing device 106. For example, the user device 112 can convert the H.263 encoded video stream into a H.264 encoded stream that the video codec 109 is able to decode. Alternatively, the user device 112 can convert the Theora encoded video stream into decoded video data and provide the decoded video data to the television processing device 106. The user device 112 can provide the television processing device 106 with a URL that identifies the transcoded content on the user device 112, and the television processing device 106 can retrieve the transcoded content from the user device 112 for processing and display on the display device 108.

In some implementations, the user device 112 or 114 can perform container transcoding. Codec transcoding typically requires more processing resources than container transcoding. In container transcoding, decoding and encoding of the content is not required. Instead, only the wrapper of the encoded video and audio packets (and, if needed, file headers, index tables, etc.) is transformed from a first format to a second format that the display device is capable of parsing and decoding. For example, web videos may be delivered using H.264 video encoding in a Flash video (FLV) container. The television processing device 106 may include an H.264 decoder, but may only be capable of decoding H.264 video in MP4 containers and not H.264 video in FLV containers. In such an example, the user device 112 may transform the container around the H.264 video and audio packets into a format that the television processing device 106 is capable of parsing and decoding, substantially without transcoding the video and audio packets themselves.

In some implementations, the user device 112 or 114 can be the source of the content 102. For example, the user device 112 may encode a copy of the content of its own display as a video stream, and provide the video stream to the television processing device 106 for display on the display device 108. In another example, the user device 112 may be executing a business presentation application, and may display speaker's notes on its own display while encoding and streaming respective presentation slides as the content 102 provided to the television processing device 106. In various implementations, the user device 112 or 114 may encode video footage, video conferencing, screen captures, static photos, real-time photos, or any other appropriate media that can be encoded by the user device 112 or 114 and provided to the television processing device 106. In some implementations, the user device 112 or 114 may provide a temporary network address (e.g., URL) to the television processing device 106, and the television processing device 106 may pull the media encoded by the user device 112 or 114. In some implementations, the user device 112 or 114 may push the encoded media to the television processing device 106.

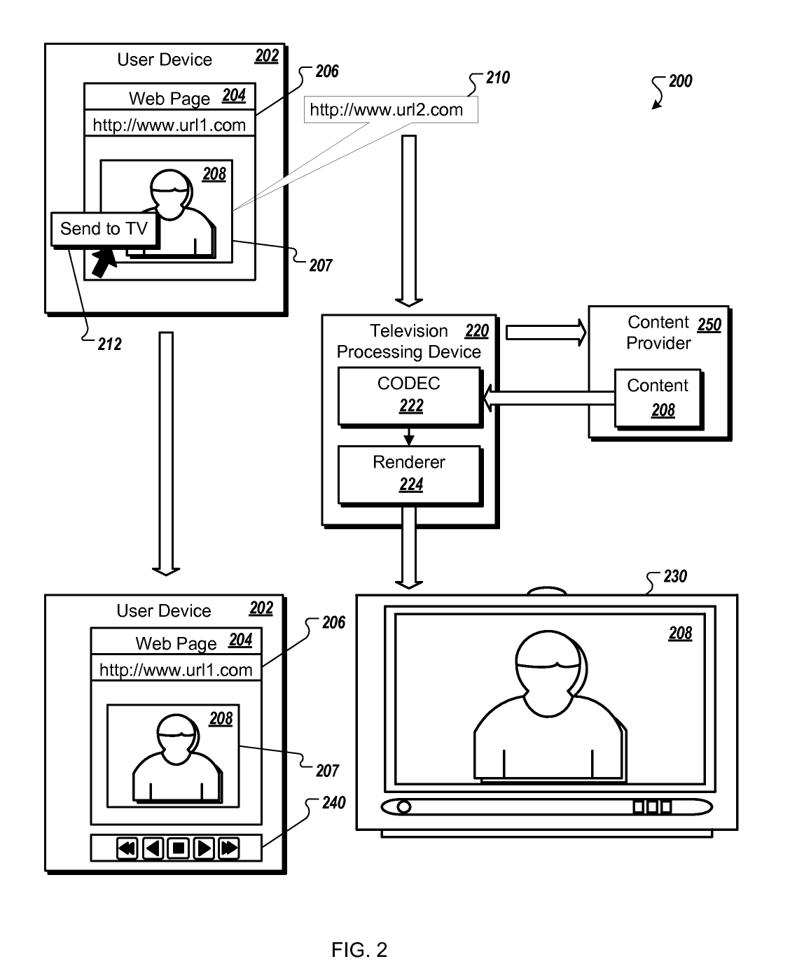

FIG. 2 is a block diagram illustrating an example flow 200 for providing content to a television processing device by use of a resource address. In some implementations, the flow 200 may be used in the environment 100 of FIG. 1. In FIG. 2, the television processing device 220 retrieves the content using a URL provided from the user device 202.

The flow 200 starts when a user device 202 is used to browse a web page 204. In some implementations, the user device 202 can be the user device 112 or 114. The web page 204 is identified by a network address 206, such as a URL, that identifies the web page 204. The web page also includes a content display area 307 in which content 208, identified by a network address 210, is presented. For example, the content 208 can be a streaming video embedded within the web page 204.

The user device 202 provides a user interface (UI) element 212, such as a button, pop up dialog, keyboard command, or other such device, the activation of which causes a television processing device 220 to display the content 208 on a display device 230 such as a television. In the illustrated example, the user's selection of the UI element 212 causes several events to occur. The user device 202 transmits the network address 210 to the television processing device 220. Additionally, the user device 202 also displays a media control UI 240 with which the user can interact to control the display of the content 208 on the display device 230. In some implementations, the media control UI 240 can include buttons for commands such as play, pause, stop, fast forward, rewind, skip, and other such media playback controls.

In some implementations, the user device 202 can communicate the network address, playback commands, or other information with the television processing device 220 over a network or other appropriate communications path. For example, the user device 202 and the television processing device 220 can communicate over a wired or wireless (e.g., Wi-Fi) Ethernet network, a Bluetooth connection, a ZigBee connection, an infrared connection (e.g., IrDA), or other appropriate wired or wireless communications path.

In some implementations, the television processing device 220 can be implemented as a Universal Plug and Play (UPnP) media renderer on a local area network, and the user device 202 can perform operations including instantiating the user device 202 as a UPnP control point present on a local area network, and discover and communicate with the television processing device 220 using a UPnP protocol. For example, the user device 202 can use a UPnP protocol to transmit the URL of a media stream to the television processing device 220, and then transmit a “play” command causing the television processing device 220 to present the media indicated by the URL. In some implementations, UPnP or other networking technology can be used by the user device 202 and the television processing device 220 to also perform tasks such as dynamically join a network, obtain network addresses, announce their identities to peer devices, convey their capabilities upon request, learn about the presence and capabilities of other networked devices, leave a network substantially without leaving any unwanted state information behind, and perform other appropriate network tasks. In some implementations, UPnP or other networking technology can be used by the user device 202 and the television processing device 220 to also remotely control networked devices, move digital data in the form of audio, video and still images between networked devices, share information among networked devices and with the World Wide Web, and perform other appropriate media and information communications tasks.

Upon receipt of the network address 210 by the television processing device 220, the television processing device 220 requests the content 208, hosted by a content provider 250, and accessible at the network address 210. In some implementations, the television processing device 220 can communicate with the content provider 250 over an open network such as the Internet. The television processing device 220 receives the content 208 from the content provider 250. The content 208 is decoded by a codec module 222. In some implementations, the codec module 222 can be configured to decode MPEG1, MPEG-2, MPEG-4, or other types of encoded media.

The decoded content is provided to a renderer module 224. The renderer module 224 formats the decoded content into a format that is compatible with the display device 230. For example, the renderer module 224 can convert the decoded content into high definition multimedia interface (HDMI), component, composite digital visual interface (DVI), video graphics adapter (VGA), Syndicat des Constructeurs d'Appareils Radiorécepteurs et Téléviseursor (SCART), other video signal formats. The rendered content is then provided to the display device 230, which displays the content. In some implementations, the television processing device 220 can be a collection of video processing hardware integrated into the display device 230. The user can use the media control UI 240 to control the playback of the content 208.

In other implementations, the television processing device 220 can receive the content 208 over a television provider network that communicates with the content provider 250 over the open network. Accordingly, the television processing device need to have a direct connection to the open network, but instead can provide the address 210 to a data processing apparatus within the television provider network, which, in turn, receives the content 208 and provides the content to the television processing device 220.

In some implementations, content types other than video can be presented. For example, the user device 202 can be an audio device, and/or the television processing device 220 can be an audio-only processing device (e.g., an Internet radio). In such an example, the user device 202 can be playing stored or streamed audio content. The user device 202 can send a URL of the audio content to the television processing device 220 to cause the television processing device 220 to retrieve, decode, and play the audio content.

In some implementations, the television processing device 220 can process the content 208 to cause a picture-in-picture or side-by-side environment to be displayed on the display device 230. For example, the picture-in-picture environment can include a display region in which the television programming content is displayed and a region in which the content is simultaneously displayed. In some implementations, the regions can be resized such that both regions can be displayed substantially without overlap. In other implementations, at least one of the regions can be made relatively smaller than the other region such that the smaller region can partially overlap the larger while still permitting both regions to be substantially visible.

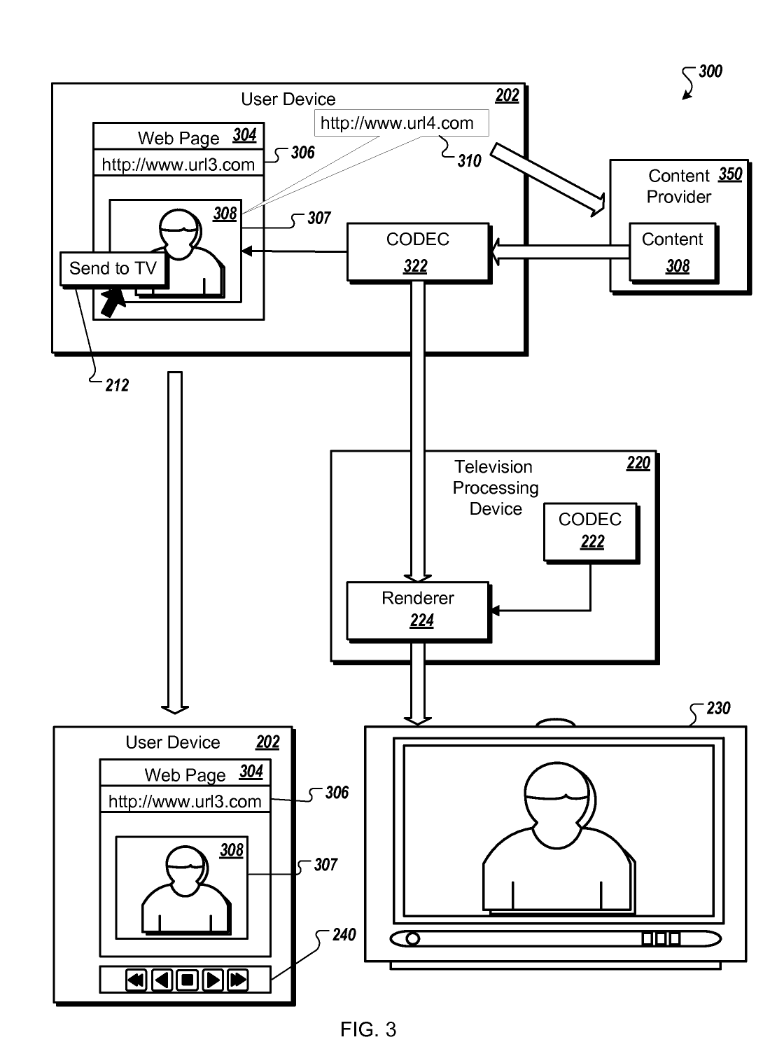

FIG. 3 is a block diagram illustrating an example flow 300 for providing content to a television processing device by use of transcoding. In some implementations, the flow 300 can be used in the environment 100 of FIG. 1. In FIG. 3, the television processing device 220 receives content that has been decoded by the user device 202.

The flow 300 starts when the user device 202 is used to browse a web page 304. The web page 304 is identified by a network address 306, such as a URL, that identifies the web page 304. The web page also includes a content display area 307 in which a content 308, identified by a network address 310, is presented. For example, the content 308 can be a streaming video embedded within the web page 304. In some implementations, the user device 202 can process the format and encoding of the content 308 to determine if the television processing device 220 can process the content 308 according to a determined format and encoding. In some implementations, the television processing device 220 can make the user device 202 aware of its decoding abilities though a UPnP or other appropriate communications protocol. In the illustrated example, the content 308 is encoded using a compression or encryption format that the television processing device 220 is not configured to process. For example, the content 308 may be encoded as AVI while the codec module 222 may not be compatible with that format.

In the illustrated example, the user's selection of the UI element 212 requests the content 308 from a content provider 350 that hosts the content 308. The user device 202 processes the content 308 using a codec module 322. The codec module 322 decodes or decrypts the content 308 and converts the content 308 into a format that can be rendered by the rendering module 224. In some implementations, the user device 202 may be the content provider 350. For example, the user device may host or create the content 308, wherein the content 308 can be media files stored on the user device 202, or the content 308 can be audio and/or video content dynamically created by the user device 202 (e.g., software running on the user device can generate an MPEG-2 or other appropriate audio and/or video stream).

In some implementations, the codec module 322 can convert the content 308 into a format that is compatible with the codec module 222, and the codec module 222 decodes the content 308 for rendering by the rendering module 224. For example, the communications link between the user device 202 and the television processing device 220 may have insufficient bandwidth to carry a decompressed video stream from the codec module 322 to the rendering module 224. As such, the codec module 322 may transcode the content 308 into a different compressed format that is compatible with the codec module 222, and transmit the transcoded content to the codec module 222 using the compressed format. For example, the content 308 may be encoded using the Theora video compression format, and the codec module 322 transcodes the content from Theora to MPEG-2, or another format that the codec module 222 is capable of decoding. In some implementations, the content can be transmitted from the user device 202 to the television processing device 220 over a wired or wireless local area network, a peer-to-peer network, a one-to-one connection, or other appropriate communications medium. In some implementations, the content may be transcoded into another compressed format in order to conserve communications bandwidth. For example, the user device 202 can be capable of decoding Theora (or other format) to a substantially uncompressed format, however, such an uncompressed format may require more bandwidth than available or practical for the local Wi-Fi network is handle. By transcoding one compressed format into another, the bandwidth required for transporting the content 208 from the user device 202 to the television processing device 220 may be reduced to levels that the network is better able to transport.

The renderer module 224 formats the decoded content into a format that is compatible with the display device 230. For example, the renderer module 224 can convert the decoded content into HDMI, component, composite, DVI, VGA, SCART, or other video signal formats. The rendered content is then provided to the display device 230, which displays the content. The user can use the media control UI 240 to control the playback of the content 208. For example, the user can interact with the media control UI 240 to cause the user device 202 to communicate with the television processing device 220 to cause the content 308 to be played, paused, stopped, advanced, reversed, or otherwise appropriately controlled.

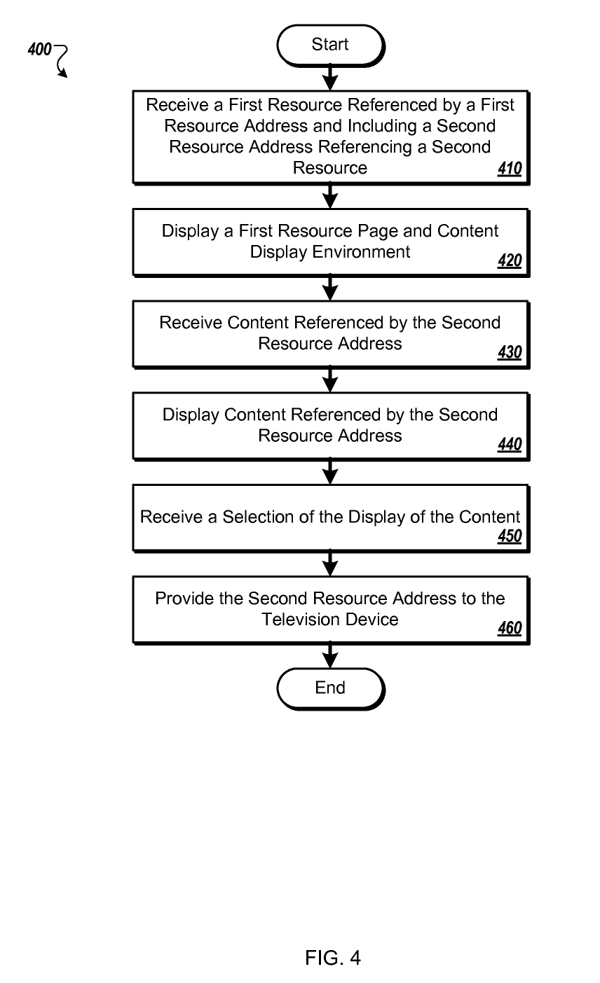

FIG. 4 is a flow diagram of an example process 400 for providing content extracting from an open network to a television processing device. In some implementations, the process 400 can be performed by the user device 112 and 114 of FIG. 1.

The process 400 starts at step 410, when a first resource, referenced by a first resource address, is received. The first resource defines a first resource page and a content display environment in the first resource page. For example, the first resource can be the web page 204 of FIG. 2, which is associated with the network address 206 and defines the content display area 207. The first resource includes a second resource address referencing a second resource, the second resource defining content that is displayed in the content display environment in the first resource page. For example, the web page 204 includes the network address 210 with references the content 208 which is presented in the content display area 207.

At step 420, the first resource page and the content display environment are displayed. For example, the web page 204, which includes the content display area 207, is displayed by the user device 202. At step 430, the content referenced by the second resource address is received, and at step 440, the content referenced by the second resource address is displayed. For example, the content 208, referenced by the network address 210, is received by the user device 202 and displayed in the content display area 207.

At step 450, a selection of the display of the content in the content display environment is received. For example, the user can select the UI element 212 to select the content 208 as is it displayed by the user device 202. In response to receiving the selection, at step 460, the second resource address is provided to the television device. For example, the user device 202 transmits the network address 210 to the television processing device 220. In some implementations, other information may be provided to the television processing device in addition to the resource address. For example, the user device 202 may transmit the full HTTP request header, which may include the resource location, headers for cookies, and other appropriate information. In some implementations, by providing such information, the television processing device is able to start streaming the content using the login credentials that the user may have provided from the user device 202. By providing the additional information, the television display device is immediately able to start streaming the video content without requiring re-submission of login credentials from the user.

In some implementations, the user device 202 may modify the information prior to transmission to the television processing device. For example, some video websites stream different types of video to different devices (e.g., low-quality video to mobile devices, higher-quality to desktops). Before sending the URL and HTTP headers to the television processing device, the user device 202 may modify the user-agent header in the HTTP request so that a format suited for the television processing device is selected.

In some implementations, the network address 210 can be transmitted to the television processing device 220 through a local area network, through a wide area network (e.g., via a server that bridges communications between the user device 202 and the television processing device 220), over a peer-to-peer connection (e.g., Bluetooth), over a one-to-one connection (e.g., an infrared link), or through any other appropriate communications path. In response to receipt of the network address 210, the television processing device 220 requests the content 208 from the content provider 250, and presents the content 208.

In some implementations, the user device 202 and/or the television processing device 220 can make the network address 206 and/or 210 available to other user devices. For example, a user device can query the user device 202 and/or the television processing device 220 while the content 208 is being presented to retrieve the network address 206 and/or 210. Using the network address 206, the user device can request and present the web page 204 on the user device. Similarly, using the network address 210, the user device can request and present the content 208 on the user device.

In some implementations, the user device 202 and/or the television processing device 220 can notify other user devices that the television processing device 220 has been directed to present the content 208. For example, in response to receiving the network address 210, the television processing device 220 can broadcast the network address 206 and/or 210 to other user devices. The other user devices can use the broadcast address information to request and present the content 208 or the web page 204. In some implementations, presentation of the content 208 can be substantially synchronized on the user device 202 and the television processing device 220. For example, the user can press a “play” button on the media control UI 240, and playback of the content 208 can start substantially simultaneously on both the user device 202 and the television processing device 220. In such an example, the user can initiate playback on the display device 230 and then leave the room while carrying the user device 202 in order to keep viewing or listening to the content 208.

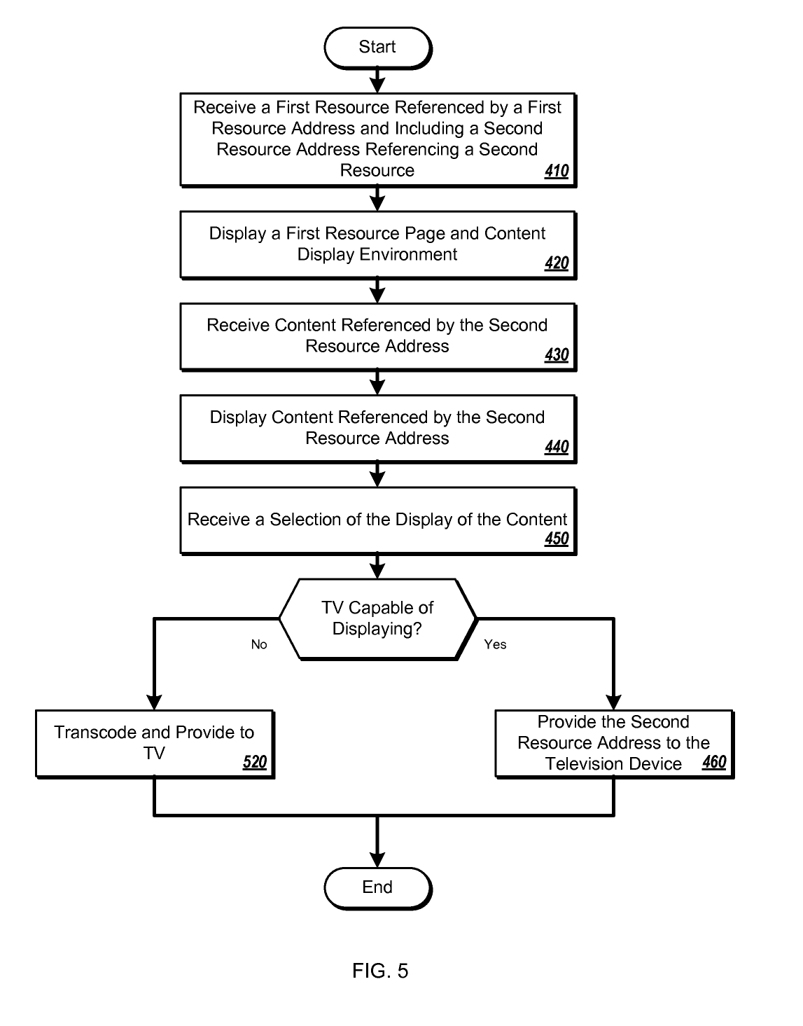

FIG. 5 is a flow diagram of an example process 500 for selecting a content provisioning process that is dependent on television processing device capabilities. The process 500 is an extension of the steps 410-450 of the process 400. As described previously, at step 450, a selection of the display of the content in the content display environment is received. At step 510, the user device determines whether the television device in data communication with the user device has a processing capability to retrieve the content from the second resource address and display the content. For example, the codec module 222 may not be capable of decoding the format in which the content 308 of FIG. 3 is encoded. The user device can make the determination by querying the television device for its capabilities, or by referencing an external database of the television provider that describes the capabilities of the television device, or by sending a portion of the content to the television processing device and monitoring for an error condition or a successful decoding of the content by the television processing device. For example, the user device 202 can use a UPnP protocol to query the television processing device 220 to retrieve information about the decoding capabilities of the television processing device 220. In another example, the user device 202 can query the television processing device 220 to determine the make and model of the television processing device 220, and then use the make and model information to a query a database that provides information about the decoding capabilities of various television processing devices.

If at step 510, it is determined that the television device is capable of retrieving and decoding the content, then the second resource address is provided to the television device, and the process 500 continues in a manner similar to the process 400 of FIG. 4.

If, however at step 510, it is determined that the television device is not capable of retrieving and decoding the content, then at step 520 the user device transcodes the content into transcoded content for which the television has the processing capability to display. For example, the user device 202 can use the codec module 322 to translate the content 308 from its native format into a format that can be rendered by the rendering module 224 or decoded by the codec module 222.

In some implementations, the user device 202 buffer a predetermined amount of transcoded content, and transmit its own network address to the television processing device 220 through a local area network, through a wide area network (e.g., via a server that bridges communications between the user device 202 and the television processing device 220), over a peer-to-peer connection (e.g., Bluetooth), over a one-to-one connection (e.g., an infrared link), or through any other appropriate communications path. In response to receipt of the network address 210, the television processing device 220 requests the transcoded content from the user device 202 (e.g., over a local area network), and presents the content 208.

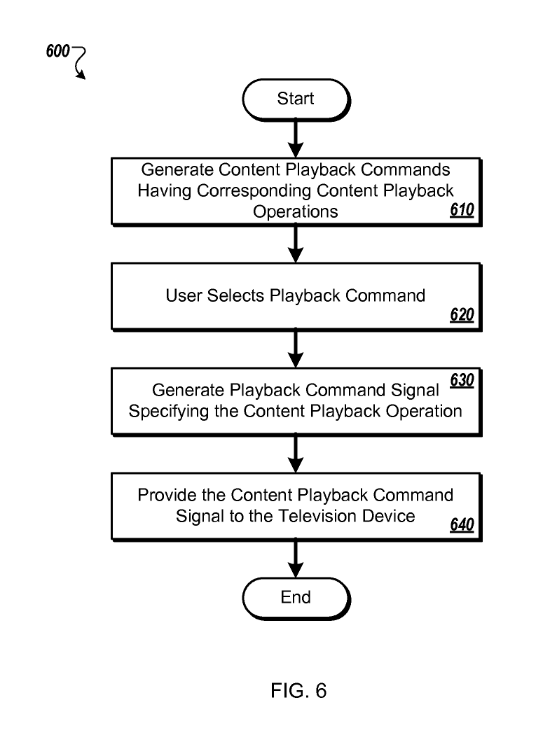

FIG. 6 is a flow diagram of an example process 600 for generating a command user interface at a user device in response to providing content to a television processing device. In some implementations, the command user interface can be the media control UI 240 of FIGS. 2 and 3, which provide user controls for commands such as play, stop, fast forward, and rewind.

The process 600 begins at step 610, in which a plurality of content playback commands is generated in the display device. Each command has a corresponding content playback operation. For example, the media control UI 240 is displayed by the user device 202, and the UI 240 includes various buttons that the user can select to control media playback. In some implementations, the functions provided by the UI 240 can be at least partly selected from the functions determined to be provided by the television processing device 220. For example, the television processing device 220 can transmit a description of its media transport and playback capabilities to the user device 202. The user device 202 can then process this description to determine what buttons to present in the UI 240.

At step 620, the user selects a playback command. For example, the user can click or otherwise select a “play” button on the medial control UI 240. In response to the user selection, a playback command signal specifying the corresponding content playback operation is generated at step 630.

At step 640, the content playback command signal is provided to the television device to cause the television device to perform the specified content playback operation. For example, the user device 202 can transmit the command to the television processing device 220, and the television processing device 220 can respond by performing the command selected by the user. In some implementations, the playback commands can be UPnP commands that can communicate media transport and control instructions from the user device 202 to control the television processing device 240.

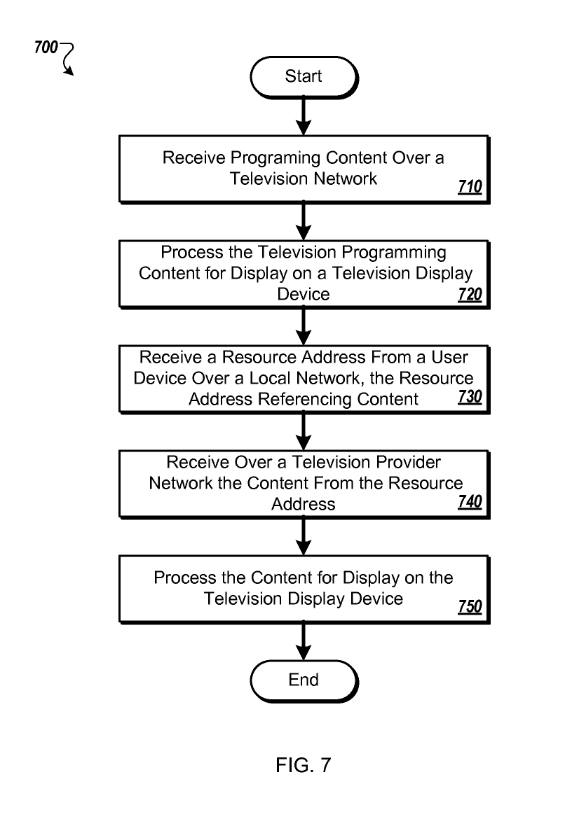

FIG. 7 is a flow diagram of an example process 700 of processing content at a television processing device. In some implementations, the process 700 can be performed by the television processing device 106 of FIG. 1. The process 700 begins when the television processing device receives programming content over a television network. At step 720, the television programming content is processed for display on a television display device. For example, the television processing device 106 can receive television programming signals from the television provider 107, and process the signals for display on the display device 108.

At step 730, a resource address from a user device is received over a local area network, the resource address referencing content. For example, the television processing device 222 of FIG. 2 can receive the address or other identifier of media content (e.g., video-on-demand), which references the content 208, from the user device 202 over local area network or a personal area network communications link.

At step 740, the content is received over a television provider network from the resource address. For example, the television processing device 220 which is subscribed to a cable television provider can request a video-on-demand selection through the cable connection. In another example, the television processing device 220 can request the cable television provider to stream a requested content at the resource address.

At step 750, the content is processed for display on the television display device. For example, the television processing device 220 can receive the content 208, and decode the content 208 for presentation. In another example, the user device 202 can determine that the television processing device 220 is not capable of decoding the content 208, and instead can transcode the content 208 into a format that the television processing device 220 can process. In such examples, the user device 202 can provide the television processing device 220 with a resource address that points to the transcoded content, and the television processing device 220 can request, process, and present the transcoded content.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A television processing device, comprising:
a data processing apparatus;
a communication subsystem that transmits and receives data over one or more networks and one or more media; and
a memory device storing instructions that when executed by data processing apparatus cause the user device to perform operations comprising:
receive programming content over a television network and process the television programming content for display on a television display device;
receive a resource address from a user device over a local area network, the resource address referencing content;
receive over the one or more networks the content from the resource address; and
process the content for display on the television display device.

2. The television device of claim 1, wherein to process the content for display on the television display device, the device performs operations comprising:
processing the content to display in a picture-in-picture environment on the television display device, the picture-in-picture environment having a first environment in which the television programming content is displayed and a second environment in which the content is displayed, and wherein the first and second environments are displayed simultaneously.

3. The television device of claim 1, wherein the resource address is a uniform resource locator.

4. The television device of claim 1, wherein the content is H.264 encoded video.

5. The television device of claim 1, wherein the operations further comprise:
receiving a query, from a requesting user device, for the resource address; and, providing the resource address to the requesting user device.

6. The television device of claim 1, wherein the television device is implemented as a Universal Plug and Play (UPnP) control point on a local area network, wherein the television device is discoverable and communicable by the user device using a UPnP protocol.

7. The television device of claim 1, wherein receiving over the one or more networks the content from the resource address comprises receiving the content over the television network.

8. A method implemented in a television processing device, comprising:
receiving, by a television processing device, programming content over a television network and processing the television programming content for display on a television display device;
receiving, by the television processing device, a resource address from a user device over a local area network, the resource address referencing content;
receiving, by the television processing device and over one or more networks, the content from the resource address; and,
processing, by the television processing device, the content for display on the television display device.

9. The method of claim 8, wherein processing the content for display on the television display device comprises:
processing the content to display in a picture-in-picture environment on the television display device, the picture-in-picture environment having a first environment in which the television programming content is displayed and a second environment in which the content is displayed, and wherein the first and second environments are displayed simultaneously.

10. The method of claim 8, wherein the resource address is a uniform resource locator.

11. The method of claim 8, wherein the content is H.264 encoded video.

12. The method of claim 9, wherein the television device is implemented as a Universal Plug and Play (UPnP) control point on a local area network, wherein the television device is discoverable and communicable by the user device using a UPnP protocol.

13. The method of claim 1, wherein receiving over the one or more networks the content from the resource address comprises receiving the content over the television network.

14. A computer program stored in a computer readable storage device, the computer program comprising instructions that when executed by a television processing device cause the television processing device to perform operations comprising:
receiving programming content over a television network and process the television programming content for display on a television display device;
receiving a resource address from a user device over a local area network, the resource address referencing content;
receiving over one or more networks the content from the resource address; and
processing the content for display on the television display device.

15. The computer program product of claim 14 wherein processing the content for display on the television display device comprises:
processing the content to display in a picture-in-picture environment on the television display device, the picture-in-picture environment having a first environment in which the television programming content is displayed and a second environment in which the content is displayed, and wherein the first and second environments are displayed simultaneously.

16. The computer program product of claim 14, wherein the resource address is a uniform resource locator.

17. The computer program product of claim 14, wherein the content is H.264 encoded video.

18. The computer program product of claim 14, wherein the television device is implemented as a Universal Plug and Play (UPnP) control point on a local area network, wherein the television device is discoverable and communicable by the user device using a UPnP protocol.

19. The computer program product of claim 17, wherein receiving over the one or more networks the content from the resource address comprises receiving the content over the television network.
